(19) United States
(12) Patent Application Publication
(10) Pub. No.: US 2010/0147757 A1
(43) Pub. Date: Jun. 17, 2010

(54) DESALINATION SYSTEM

(75) Inventor: Stephen John Hastings, Endeavour Hills (AU)

Correspondence Address: HARNESS, DICKEY & PIERCE, P.L.C., P.O. BOX 828, BLOOMFIELD HILLS, MI, 48303, US

(73) Assignee: WOODSHED TECHNOLOGIES LIMITED, Melbourne (AU)

(21) Appl. No.: 12/519,493

(22) PCT Filed: Dec. 14, 2007
(86) PCT No.: PCT/AU07/01940

§ 371 Date: Feb. 1, 2010

(30) Foreign Application Priority Data
Dec. 18, 2006 (AU) 2006907051

(51) Int. Cl. C02F 1/44; C02F 1/58

(52) U.S. Cl. 210/170.11

(57) ABSTRACT

A desalination system comprising at least one water-containing vessel adapted to be immersed into a body of sea water, an inlet at the lower end of the vessel, pump means for removing water from the vessel, valve means for selectively enabling and preventing flow of sea water into the vessel via the inlet under the effect of hydrostatic pressure, and a desalination plant powered by water flowing into the vessel when the valve means is open.

The present invention relates to a system for desalination of water.

In my International patent application no. PCT/AU2006/001034 the entire disclosure of which is hereby incorporated by reference there is disclosed a system for generating electricity comprising a water containing vessel immersed into a body of water with the lower end of the vessel spaced above the water bed, an inlet at a lower end of the vessel, valve means for selectively enabling and preventing flow of water into the vessel via the inlet under the effect of hydrostatic pressure, a pump for at least partially emptying the vessel of water, a turbine within the vessel and driven by water flowing into the vessel via the inlet when the valve is open, and a generator driven by the turbine. The vessel itself can be in the form of a tube submerged into the body of water with its axis extending substantially vertically or a vessel which floats in the water.

Effectively, emptying of the vessel by operation of the pump creates a pressure differential between the interior of the vessel and the body of water whereby potential energy is stored within the system and which is released to cause the turbine to be driven when the valve is next opened. Although, of course, the net energy output from the generator will be less than the energy input required to drive the pump, by operating the system to generate electricity during periods of premium pricing and driving the pump during pumps of minimum pricing, commercially effective power generation can be achieved. The pump can be operated using low price electricity and/or can use energy from solar and/or wind power and/or other available energy sources such as tidal or wave whereby that energy is also “stored” within the system.

The present invention relates to an adaptation of the basic principles of hydrostatic energy storage within the generation system for other uses, specifically desalination.

According to the present invention, there is provided a desalination system comprising at least one water-containing vessel adapted to be immersed into a body of sea water, an inlet at the lower end of the vessel, pump means for removing water from the vessel, valve means for selectively enabling and preventing flow of sea water into the vessel via the inlet under the effect of hydrostatic pressure, and a desalination plant powered by water flowing into the vessel when the valve means is open.

In one embodiment of the invention the desalination plant is incorporated within the vessel such that sea water flowing into the vessel pressurises a salt water side of the desalination plant and the pump means removes water from a fresh water side of the desalination plant whereby to create a hydrostatic pressure differential between the salt water and fresh water sides of the plant to thereby drive the desalination process.

In an alternative embodiment of the invention the sea water entering the vessel compresses air within the vessel and the desalination plant is powered by the compressed air.

Preferably, the desalination plant operates by reverse osmosis between the salt water and fresh water sides.

Embodiments of the invention will now be described by way of example only with reference to the accompanying drawings in which:

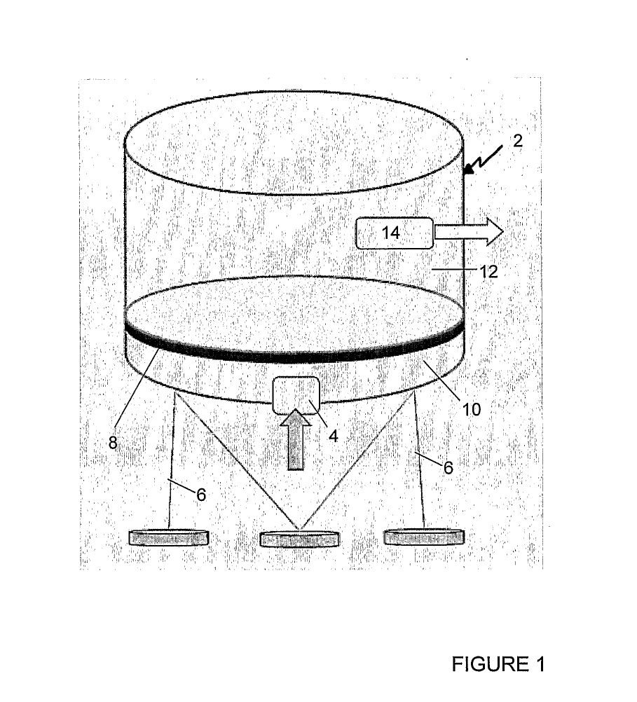

FIG. 1 shows schematically a desalination system in accordance with a first embodiment of the invention; and

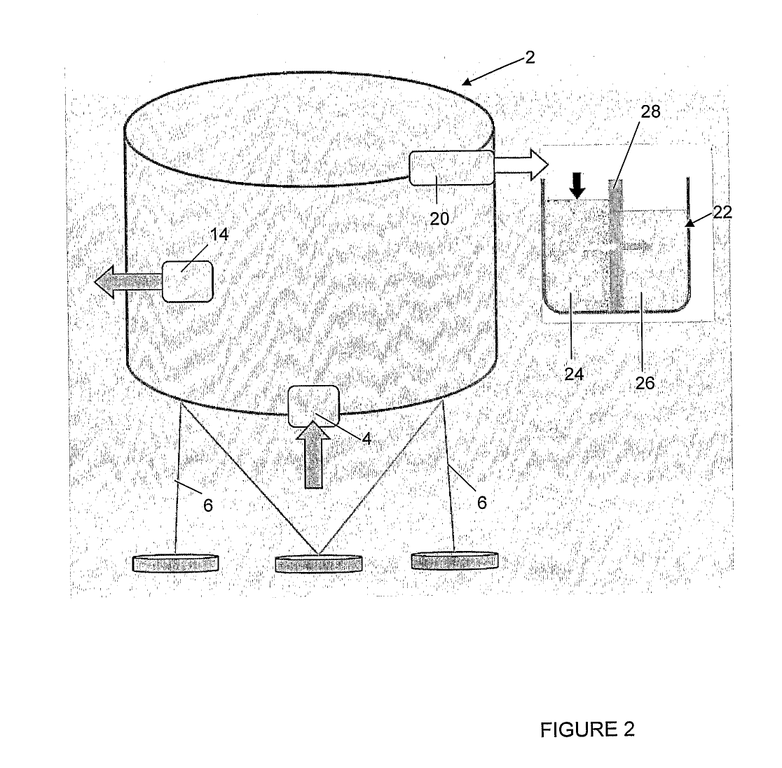

FIG. 2 shows schematically a desalination system in accordance with a second embodiment of the invention.

With reference to FIG. 1, a desalination system in accordance with a first embodiment of the invention comprises a vessel 2 immersed to a substantial depth in a body of sea water. At its lower end at the maximum depth of immersion, the vessel includes a water inlet controlled by one or more valves 4. The vessel 2 is tethered to the sea bed by cables 6 and in this form could be a free-floating structure. Alternatively it may be suspended at its upper end from a structure such as a platform mounted above the surface of the water and anchored in position relative to the sea bed by legs or pylons, or may be fixed to a free-floating or tethered platform.

The interior of the vessel 2 is divided by structure 8 including a semi-permeable reverse osmosis membrane into a lower inlet chamber 10 into which sea water flows at high hydrostatic pressure when the valve 4 is opened, and above the membrane structure 8 a chamber 12 for fresh water produced by filtration of the sea water passing through the membrane structure 8. The fresh water within the fresh water chamber 12 is removed from the upper chamber by operation of a pump 14 and fed to a storage facility, preferably an on-shore facility. Pumping the fresh water from the chamber 12 maintains a pressure differential across the membrane structure 8 whereby the filtration process can continue under the high hydrostatic pressure of the water within the lower chamber 10. If required, filters can be incorporated within the system to remove particulates prior to passage through the membrane structure 8.

The pump 14 can be operated by off-peak, low price, electricity and/or by other energy sources such as wind and/or solar, wave, tidal or sea floor natural gas at high pressure whereby pumping of fresh water from the fresh water chamber 12 when such energy is available not only delivers the fresh water to the storage facility it also effectively “stores” energy within the system in a similar manner to that disclosed in my International patent application discussed earlier.

In addition to the energy storage effect and which may be particularly beneficial depending on the type of energy used to drive the pump, it is envisaged that significant savings and capital cost may be achieved as the size of pump needed to empty fresh water from the fresh water chamber is likely to be smaller than that required to directly pressurise the salt water side of a comparable conventional desalination unit.

In order to maximise the pressure differential across the membrane structure, the lower end of the vessel 2 should be set at a substantial depth of immersion, for example 10 to 60 metres. To increase the depth of immersion where geological conditions permit, the vessel 2 can be sunk at least partially into a sump cut into the sea bed and tethered by cables to the base of the pump. The vessel 2 may be partially or fully submerged; if partially submerged it may be open at its upper end. If the vessel itself is a free-floating structure, as its fresh water chamber progressively fills with water, the vessel will gently lower in the water to maintain the hydrostatic head pressure.

In the embodiment shown in FIG. 2, the vessel 2 is closed at its upper end and forms an air compression chamber. With the inlet valve 4 closed, sea water can be pumped out of the vessel by operation of the pump 14 powered by off-peak low price electricity and/or by other energy sources such as wind and/or solar, wave, tidal, or sea floor natural gas at high pressure. When the inlet valve 4 is opened, sea water entering the vessel 2 at high hydrostatic pressure will cause compression of air within the upper part of the chamber, the compressed air being driven through an air turbine 20 which drives a pump to force sea water through a membrane structure of an adjacent desalination unit 22. The desalination unit may be any suitable commercially available unit and as shown schematically comprises a salt water chamber 24, a fresh water chamber 26 and a semi-permeable membrane structure 28 between the two chambers. As with the previous embodiment, with the inlet valve 4 closed, the pump 14 can be operated to empty the vessel whenever a suitable energy source is available whereby that energy is stored within the system as hydrostatic potential energy. Although the system may operate with just a single vessel, it is envisaged that an array of two or more such vessels may be used to feed a single desalination unit.

In a variation of this embodiment, instead of the air compressed within the vessel driving an air turbine, the air can be fed directly to the salt water side of the desalination unit to pneumatically pressurise the salt water at that side of the unit.

The embodiments have been described by way of example only and modifications are possible within the scope of the invention.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

1. A desalination system comprising at least one water-containing vessel adapted to be immersed into a body of sea water, an inlet at the lower end of the vessel, pump means for removing water from the vessel, valve means for selectively enabling and preventing flow of sea water into the vessel via the inlet under the effect of hydrostatic pressure, and a desalination plant powered by water flowing into the vessel when the valve means is open.

2. A desalination system according to claim 1, wherein the desalination plant is within the vessel and includes a salt water chamber and a fresh water chamber, the salt water chamber receiving sea water flowing into the vessel when the valve means is open and the pump means being operable to remove fresh water from the fresh water chamber whereby to create a hydrostatic pressure differential between the salt water and fresh water chambers to thereby drive the desalination process.

3. A desalination system according to claim 1, wherein sea water entering the vessel when the valve means is opened compresses air within the vessel and the desalination plant is powered by the compressed air.

4. A desalination system according to claim 3, wherein the air compressed within the vessel drives an air turbine which causes sea water to be pumped under pressure into a salt water chamber of the desalination plant.

5. A desalination system according to claim 3, wherein the air compressed within the vessel pressurises salt water in a salt water chamber of the desalination plant.

6. A desalination system according to claim 1, wherein the desalination plant operates by reverse osmosis.

7. A desalination system according to claim 2, wherein the desalination plant operates by reverse osmosis.

8. A desalination system according to claim 3, wherein the desalination plant operates by reverse osmosis.

9. A desalination system according to claim 4, wherein the desalination plant operates by reverse osmosis.

10. A desalination system according to claim 5, wherein the desalination plant operates by reverse osmosis.
